(19) United States
(12) Patent Application Publication
(10) Pub. No.: US 2026/0065374 A1
(43) Pub. Date: Mar. 5, 2026

(54) INFORMATION PROCESSING APPARATUS, INFORMATION PROCESSING METHOD, AND INFORMATION PROCESSING PROGRAM

(71) Applicant: KYOSOU Co., Ltd, Hashima-shi Gifu (JP)

(72) Inventor: Masataka TANI, Hashima-shi Gifu (JP)

(21) Appl. No.: 19/383,754

(22) Filed: Nov. 10, 2025

Related U.S. Application Data
(63) Continuation of application No. PCT/JP2024/017818, filed on May 14, 2024.

(30) Foreign Application Priority Data
Jul. 30, 2023 (JP) 2023-123918

(51) Int. Cl. G06Q 40/06

(52) U.S. Cl. CPC G06Q 40/068

(57) ABSTRACT

An information processing apparatus includes a control unit configured to execute: acquiring first information from each of the users belonging to a collaborative organization in which the users engaged in businesses in different fields are organized; providing the first information to a network in a browsable manner so that each of the users belonging to the collaborative organization can mutually share information; acquiring, for each of the users belonging to the collaborative organization, an amount of profit obtained from the business by the user; summing up profit return amounts for respective users, each of the profit return amounts being obtained by multiplying the amount of profit by a first rate; and calculating, for each of the users belonging to the collaborative organization, contribution cost to be obtained by multiplying the summed profit return amount by a second rate, the contribution cost being a cost to be distributed to the user.

### CROSS-REFERENCE TO RELATED APPLICATIONS

This Application claims the benefit of priority and is a Continuation application of the prior International Patent Application No. PCT/JP2024/017818, with an international filing date of May 14, 2024, which designated the United States, and is related to the Japanese Patent Application No. 2023-123918, filed Jul. 30, 2023, the entire disclosures of all applications are expressly incorporated by reference in their entirety herein.

### TECHNICAL FIELD

The present invention relates to an information processing apparatus, an information processing method, and an information processing program for managing mutual support among users.

### BACKGROUND ART

In recent years, social interest in start-up and entrepreneurship for new businesses etc. has been increasing, but there are often cases where opportunities favorable for entrepreneurship do not exist in the surroundings. For example, when funding cannot be secured, it becomes impossible to start a business, which causes many people who aspire to entrepreneurship to abandon their dreams and hopes.

Moreover, against the background that economic recovery through the development of vigorous venture businesses has become a social imperative, technique that enables business development for individual projects have been proposed.

For example, Patent Document 1 discloses a new business project contracting system that enables business development for individual projects and allows utilization of unused intellectual and technical resources. In this technique, each implementation team can participate in a project when the project belonging to their specialized knowledge field or technical field arises, and can receive compensation in an amount according to the asset distribution ratio by engaging in the project.

### PRIOR ART DOCUMENT

### Patent Document

Patent Document 1: Japanese Unexamined Patent Application Publication No. 2003-132237

### SUMMARY OF INVENTION

### Problem to be Solved by the Invention

While society is required to be transformed through the development of vigorous venture businesses, it is often difficult for individuals to continue holding dreams and hopes regarding businesses or other ventures. This is because, due to lack of experience, personal connections, credibility, or capital, situations may arise where, for example, realization of dreams and hopes is abandoned midway. The realization of individual dreams and hopes requires cooperation from many people.

According to the technique described in Patent Document 1, members of an implementation team for achieving new business projects can proceed with projects while effectively utilizing their specialized technology or knowledge. Thus, for example, when a client without appropriate knowledge or technique attempts to achieve a target project, it seems that the cooperation from many people participating as an implementation team can be obtained. However, this technique involves an implementation team proceeding with a common project while utilizing their specialized technique or knowledge, and does not implement mutual support among users when the users are proceeding with separate businesses that the respective users are engaged in.

The present disclosure is to provide configurations that enable suitable implementation of mutual support among users.

### Means for Solving the Problem

One aspect the information processing apparatus according to the present disclosure is an information processing apparatus for managing mutual support among business practice users. The present information processing apparatus comprises a control unit configured to execute: acquiring predetermined first information from each of the business practice users belonging to a collaborative organization in which the business practice users are organized, the business practice users being engaged in businesses in different fields; providing the first information to a predetermined network in a browsable manner so that each of the business practice users belonging to the collaborative organization can mutually share information; acquiring, for each of the business practice users belonging to the collaborative organization, an amount of profit obtained from the business by the business practice user; acquiring, from a manager user who invests in each of the business practice users, an investment rate for each of the business practice users; summing up profit return amounts for respective business practice users, each of the profit return amounts being obtained by multiplying the amount of profit by a predetermined first rate based on the investment rate from the manager user; calculating, for each of the business practice users belonging to the collaborative organization, a contribution rate of the business practice user by dividing the profit return amount of the business practice user by a total profit return amount that is the summed profit return amounts; and calculating, for each of the business practice users belonging to the collaborative organization, a contribution cost to be obtained by multiplying the total profit return amount by a predetermined second rate based on the contribution rate of the business practice user, the contribution cost being a cost to be distributed to the business practice user.

In the above information processing apparatus, by enabling each of the business practice users belonging to the collaborative organization to mutually share the first information, it becomes possible to mutually utilize information regarding experience, personal connections, and credibility possessed by the respective business practice users, information regarding business ideas, products, and services, and information regarding sales. Moreover, sharing returnable profits among the business practice users belonging to the collaborative organization promotes a chain of growth in the collaborative organization. To sum up, the cooperation from colleagues belonging to the same collaborative organization can be obtained for the realization of individual dreams and hopes, which enables suitable implementation of the mutual support among the business practice users.

In the above information processing apparatus, the second rate may be a rate based on the contribution rate of the business practice user in total over multiple years. According to this, even if the amount of profit of each of the business practice users fluctuates annually, the fluctuation can be mitigated by the contribution rate in total over multiple years, the contribution of each of the business practice users is continuously returned, and thereby, continuous mutual support among the business practice users is realized.

Moreover, in the information processing apparatus described above, the control unit may further execute providing recommendation information for organizing the collaborative organization to the manager user. In this case, the recommendation information may include information regarding the contribution rate of the business practice user that previously belonged to the collaborative organization and regarding a predetermined growth rate of the collaborative organization that the business practice user previously belonged to. According to this, the manager user can organize the collaborative organization after sufficiently considering combinations that can maximize the chain of growth of each of the business practice users in the collaborative organization.

The present disclosure can also be understood from an aspect of an information processing method by a computer. That is to say, the information processing method according to the present disclosure is an information processing method for managing mutual support among business practice users, wherein a computer is configured to execute: acquiring predetermined first information from each of the business practice users belonging to a collaborative organization in which the business practice users are organized, the business practice users being engaged in businesses in different fields; providing the first information to a predetermined network in a browsable manner so that each of the business practice users belonging to the collaborative organization can mutually share information; acquiring, for each of the business practice users belonging to the collaborative organization, an amount of profit obtained from the business by the business practice user; acquiring, from a manager user who invests in each of the business practice users, an investment rate for each of the business practice users; summing up profit return amounts for respective business practice users, each of the profit return amounts being obtained by multiplying the amount of profit by a predetermined first rate based on the investment rate from the manager user; calculating, for each of the business practice users belonging to the collaborative organization, a contribution rate of the business practice user by dividing the profit return amount of the business practice user by a total profit return amount that is the summed profit return amounts; and calculating, for each of the business practice users belonging to the collaborative organization, a contribution cost to be obtained by multiplying the total profit return amount by a predetermined second rate based on the contribution rate of the business practice user, the contribution cost being a cost to be distributed to the business practice user.

The present disclosure can also be understood from an aspect of an information processing program. That is to say, the information processing program according to the present disclosure is an information processing program for managing mutual support among business practice users, which causes a computer to execute: acquiring predetermined first information from each of the business practice users belonging to a collaborative organization in which the business practice users are organized, the business practice users being engaged in businesses in different fields; providing the first information to a predetermined network in a browsable manner so that each of the business practice users belonging to the collaborative organization can mutually share information; acquiring, for each of the business practice users belonging to the collaborative organization, an amount of profit obtained from the business by the business practice user; acquiring, from a manager user who invests in each of the business practice users, an investment rate for each of the business practice users; summing up profit return amounts for respective business practice users, each of the profit return amounts being obtained by multiplying the amount of profit by a predetermined first rate based on the investment rate from the manager user; calculating, for each of the business practice users belonging to the collaborative organization, a contribution rate of the business practice user by dividing the profit return amount of the business practice user by a total profit return amount that is the summed profit return amounts; and calculating, for each of the business practice users belonging to the collaborative organization, a contribution cost to be obtained by multiplying the total profit return amount by a predetermined second rate based on the contribution rate of the business practice user, the contribution cost being a cost to be distributed to the business practice user.

### Effect of the Invention

According to the present disclosure, it becomes possible to suitably implement mutual support among users.

### BRIEF DESCRIPTION OF DRAWINGS

FIG. 1 is a diagram showing a schematic configuration of an information processing system according to a first embodiment.

FIG. 2 is a diagram showing components of a server included in the information processing system according to the first embodiment in more detail, and showing components of a user terminal configured to communicate with the server.

FIG. 3 is a diagram illustrating an operation flow of the information processing system according to the first embodiment.

FIGS. 4A and 4B are diagrams for explaining profit return amounts calculated for respective business practice users.

FIGS. 5A and 5B are first diagrams for explaining contribution costs calculated for the respective business practice users.

FIGS. 6A and 6B are second diagrams for explaining contribution costs calculated for the respective business practice users.

### DETAILED DESCRIPTION OF THE INVENTION

Hereinafter, embodiments according to the present disclosure will be described based on the drawings. The configurations of the following embodiments are exemplary, and the present disclosure should not be limited to the configurations of the embodiments.

### First Embodiment

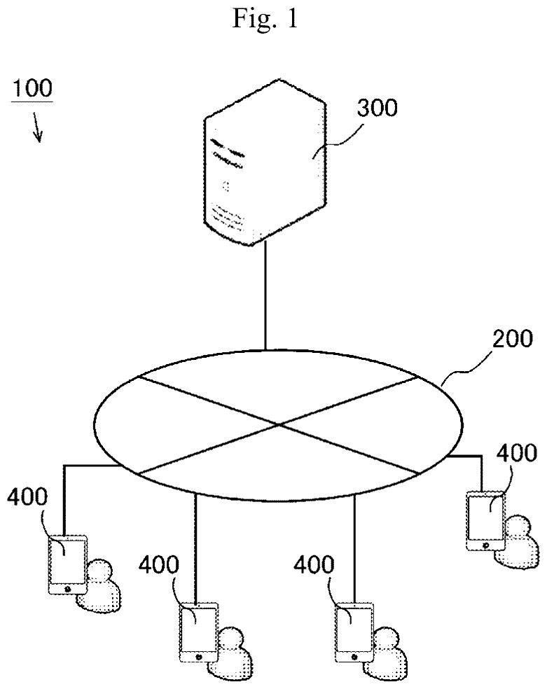

An overview of an information processing system in a first embodiment will be described with reference to FIG. 1. FIG. 1 is a diagram showing a schematic configuration of the information processing system according to the present embodiment. An information processing system 100 according to the present embodiment comprises a network 200, a server 300, and user terminals 400. The information processing system according to the present disclosure is a system for managing mutual support among users, and the management of this mutual support is executed by the server 300.

The network 200 is, for example, an IP network. If the network 200 is the IP network, the IP network may be wireless, wired, or a combination of wireless and wired. For example, in wireless communication, each of the user terminals 400 may access a wireless LAN access point (not shown) and communicate with the server 300 via LAN or WAN. The network 200 should not be limited to these examples, and may be, for example, a public switched telephone network, an optical line, an ADSL line, a satellite communication network, or the like.

The server 300 is connected to the user terminals 400 via the network 200. For simplicity of explanation in FIG. 1, one server 300 and four user terminals 400 are shown, but it goes without saying that the present disclosure should not be limited thereto.

The server 300 may be any electronic device as long as it is a computer device having processing capability for arithmetic processing and data processing such as data acquisition, generation, and updating, and may be, for example, a personal computer, a server, a mainframe, or other electronic devices. The aforementioned server 300 can be configured as a computer having a processor such as a CPU or a GPU, a main memory such as a RAM or a ROM, and an auxiliary storage unit such as an EPROM, a hard disk drive, or a removable media. The removable media may be, for example, a USB memory or a disk recording medium such as a CD or a DVD. The auxiliary storage unit stores an operating system (OS), various programs, various tables, and the like.

The server 300 may not has software, hardware, OS, etc. dedicated to the information processing system 100 according to the present embodiment. SaaS (Software as a Service), PaaS (Platform as a Service), or IaaS (Infrastructure as a Service) by a cloud server may appropriately be used for the server 300.

The user terminals 400 may be any electronic devices such as mobile terminals owned by users (business practice users or a manager user described later) who use the information processing system 100, and may be, for example, mobile terminals, tablet terminals, smartphones, wearable terminals, personal computers, or other terminal devices.

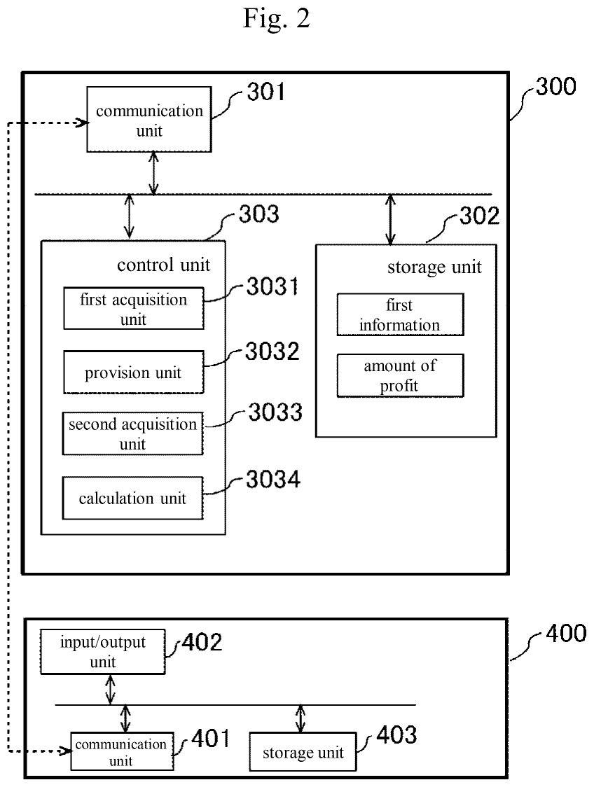

Next, detailed description of components mainly of the server 300 will be made based on FIG. 2. FIG. 2 is a diagram showing components of the server 300 included in the information processing system 100 according to the first embodiment in more detail, and showing components of one of the user terminals 400 configured to communicate with the server 300.

The server 300 has, as functional units, a communication unit 301, a storage unit 302, and a control unit 303. Programs stored in the auxiliary storage unit are loaded into a work area of the main memory and executed, each of the functional units etc. is controlled through execution of the program, and thereby, it is possible to realize functions that meet predetermined purposes in the respective functional units. However, some or all functions may be realized by hardware circuits such as an ASIC or an FPGA.

The aforementioned communication unit 301 is a communication interface for connecting the server 300 to the network 200. The communication unit 301 includes, for example, a network interface board and a wireless communication circuit for wireless communication. The server 300 is communicably connected to the user terminals 400 and other external devices via the communication unit 301.

The storage unit 302 includes the main memory and the auxiliary storage unit. The main memory is a memory for expanding programs executed by the control unit 303 and data used by the control programs. The auxiliary storage unit is a device for storing the programs executed by the control unit 303 and the data used by the control programs. The storage unit 302 also stores data transmitted from the user terminals 400 and the like, and first information described later and amounts of profit of the respective business practice users are stored in the storage unit 302. The server 300 acquires data transmitted from the user terminals 400 and the like via the communication unit 301.

The control unit 303 is a functional unit configured to be in charge of the control performed by the server 300. The control unit 303 can be realized by an arithmetic processing device such as a CPU. The control unit 303 further includes four functional units: a first acquisition unit 3031, a provision unit 3032, a second acquisition unit 3033, and a calculation unit 3034. Each of the functional units may be realized by executing a stored program by the CPU.

The first acquisition unit 3031 acquires predetermined first information from each of the business practice users belonging to a collaborative organization. The aforementioned first information is information regarding experience, personal connections, and credibility possessed by the respect business practice users. This first information may include information regarding business ideas, products, and services, and information regarding sales. The aforementioned collaborative organization is an organization of a plurality of the business practice users engaged in businesses in different fields. Such first information is transmitted from the user terminals 400 of the business practice users. The first acquisition unit 3031 acquires the first information by acquiring such information transmitted from the user terminals 400 of the business practice users, and stores this information in the storage unit 302 of the server 300.

Each of the user terminals 400 according to the present embodiment has, as functional units, a communication unit 401, an input/output unit 402, and a storage unit 403. The communication unit 401 is a communication interface for connecting the user terminal 400 to the network 200. The communication unit 401 includes, for example, a network interface board, and a wireless communication circuit for wireless communication. The input/output unit 402 is a functional unit for displaying information transmitted from outside via the communication unit 401 and for inputting information when transmitting information to the outside via the communication unit 401. The storage unit 403 includes a main memory and an auxiliary storage unit, similar to the storage unit 302 of the server 300.

Furthermore, the input/output unit 402 has a display unit 4021, an operation input unit 4022, and an image/audio input/output unit 4023. The display unit 4021 has a function of displaying various information, and is realized by, for example, an LCD (Liquid Crystal Display) display, an LED (Light Emitting Diode) display, an OLED (Organic Light Emitting Diode) display, or the like. The operation input unit 4022 has a function of receiving operation input from a user, and is specifically realized by soft keys such as a touch panel, or hard keys. The image/audio input/output unit 4023 has a function of receiving input of images such as still images and moving images, and is specifically realized by a camera using an image sensor such as Charged-Coupled Devices (CCD), Metal-oxide-semiconductor (MOS), or Complementary Metal-Oxide-Semiconductor (CMOS). The image/audio input/output unit 4023 also has a function of receiving audio input/output, and is specifically realized by a microphone or a speaker.

The business practice users can transmit the first information to the server 300 using the user terminals 400 configured as described above. Herein, the server 300 may provide interfaces for inputting the first information to the user terminals 400. Then, the business practice users can transmit the first information to the server 300 by inputting information to the interfaces via the user terminals 400.

The provision unit 3032 provides the first information to the network 200 in a browsable manner. Herein, the provision unit 3032 can provide the first information so that each of the business practice users belonging to the collaborative organization can mutually share information by transmitting the first information acquired from each of the business practice users to the network 200. The business practice users can browse the first information transmitted to the network 200 in this manner via the user terminals 400. At this time, the server 300 may provide interfaces for browsing the first information to the user terminals 400.

The second acquisition unit 3033 acquires, for each of the business practice users belonging to the collaborative organization, an amount of profit obtained from the business by the business practice user. As described above, the business practice users belonging to the collaborative organization are engaged in businesses in different fields. In other words, the aforementioned amount of profit is an amount of profit from each business in different fields. Such amount of profit is transmitted from the user terminal 400 of the business practice user. The second acquisition unit 3033 acquires the amount of profit by acquiring such information transmitted from the user terminal 400 of the business practice user, and stores the amount of profit in the storage unit 302 of the server 300.

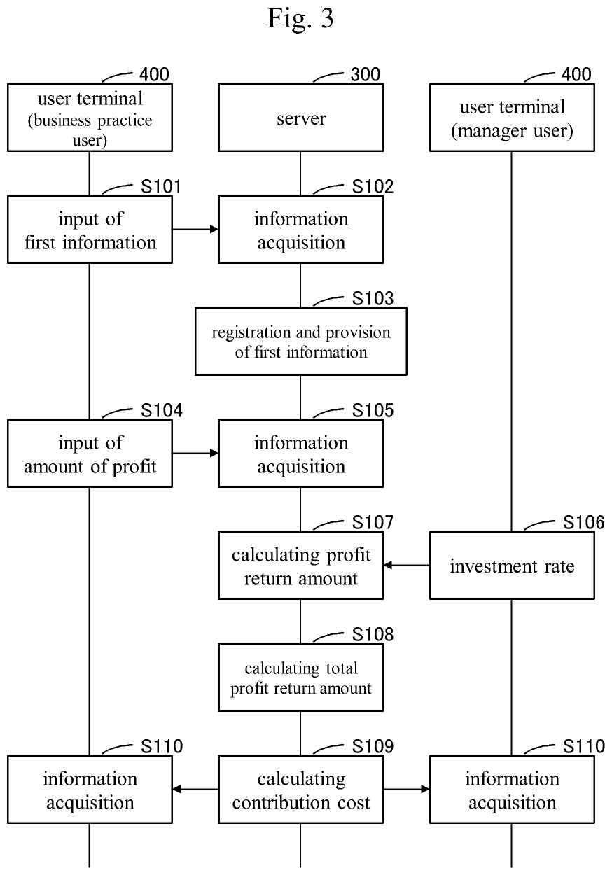

The calculation unit 3034 sums up, regarding profit return amounts described later, the profit return amounts for the respective business practice users. Then, the calculation unit 3034 calculates, for each of the business practice users belonging to the collaborative organization, a contribution cost described later. Details of the processing executed by the calculation unit 3034 will be described based on FIG. 3 described later.

The aforementioned control unit 303 functions as the control unit according to the present disclosure by executing the processing of the first acquisition unit 3031, the provision unit 3032, the second acquisition unit 3033, and the calculation unit 3034.

Herein, an operation flow of the information processing system 100 according to the present embodiment will be described. FIG. 3 is a diagram illustrating an operation flow of the information processing system 100 according to the present embodiment. In FIG. 3, the operation flow between the components in the information processing system 100 according to the present embodiment and the processing executed by each of the components will be explained.

In the present embodiment, first, the first information is input to the user terminals 400 of the business practice users (S101). Herein, the first information is information regarding experience, personal connections, and credibility possessed by the respective business practice users, and each of the business practice users can input the first information to the user terminal 400 using a predetermined interface. Then, the first information is transmitted from the user terminal 400 of the business practice user to the server 300.

The server 300 acquires the first information transmitted from the user terminals 400 of the business practice users (S102). Then, the server 300 stores the first information in the storage unit 302, registers the first information in a predetermined database, and provides the first information by transmitting this registration information to the network 200 (S103).

Since the first information is provided in the browsable manner so that each of the business practice users belonging to the collaborative organization can mutually share information in this way, the business practice users can mutually utilize information regarding experience, personal connections, and credibility possessed by other users, information regarding business ideas, products, and services, and information regarding sales, and the cooperation from the colleagues belonging to the same collaborative organization can be obtained when practicing their own business. To sum up, the mutual support among the users is thereby realized.

Next, the amounts of profit are input to the user terminals 400 of the business practice users (S104). Herein, the amounts of profit are amounts of profit that the respective business practice users belonging to the collaborative organization obtained from their own business, and can be input to the respective user terminals 400 of the business practice users. Then, the amounts of profit are transmitted from the user terminals 400 of the business practice users to the server 300.

The server 300 acquires the amounts of profit transmitted from the user terminals 400 of the business practice users, and stores the amounts of profit in the storage unit 302 (S105). The server 300 acquires the amounts of profit for the respective business practice users by acquiring the amounts of profit transmitted from the respective user terminals 400 of the business practice users.

An investment rate is input to the user terminal 400 of the manager user (S106). The aforementioned investment rate is a predetermined rate of investment from the manager user to each of the business practice users. Then, the investment rate for each of the business practice users is transmitted from the user terminal 400 of the manager user to the server 300.

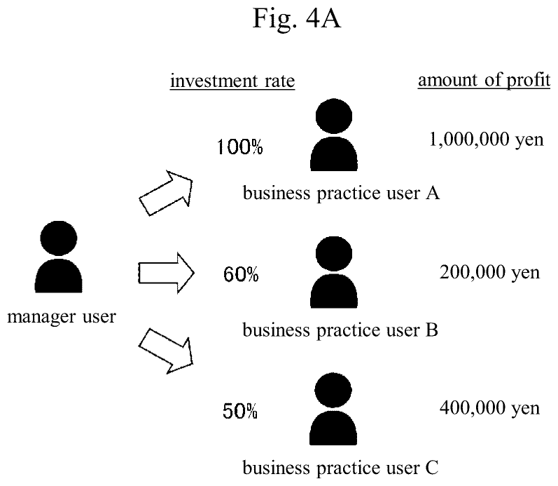

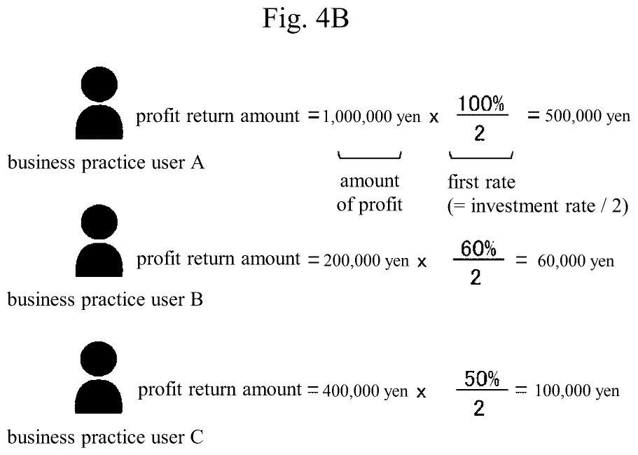

The server 300 acquires the investment rate transmitted from the user terminal 400 of the manager user, and then calculates the profit return amounts (S107). Herein, each of the profit return amounts is an amount obtained by multiplying the amount of profit by a predetermined first rate based on the investment rate from the manager user, and is calculated for each of the business practice users. This will be described below based on FIGS. 4A and 4B.

FIGS. 4A and 4B are diagrams for explaining the profit return amounts calculated for the respective business practice users. Herein, FIG. 4A is a diagram illustrating the amounts of profit and the investment rates from the manager user for three business practice users (business practice users A, B, and C), and FIG. 4B is a diagram showing an example of calculating the profit return amounts based on the information shown in FIG. 4A.

In the present embodiment, as shown in FIG. 4B, the first rate is set to investment rate divided by two. For business practice user A, the amount of profit is 1,000,000 yen, and the investment rate from the manager user is 100%. To sum up, the first rate is 50%, and thereby, the profit return amount is calculated as 500,000 yen. Similarly, for business practice user B, the amount of profit is 200,000 yen, and the investment rate from the manager user is 60%. To sum up, the first rate is 30%, and thereby, the profit return amount is calculated as 60,000 yen. For business practice user C, the amount of profit is 400,000 yen, and the investment rate from the manager user is 50%. To sum up, the first rate is 25%, and thereby, the profit return amount is calculated as 100,000 yen.

Returning to FIG. 3, the server 300 calculates a total profit return amount (S108). Herein, the total profit return amount is calculated by summing up the profit return amounts for the respective business practice users, and in the example shown in FIGS. 4A and 4B above, the total profit return amount is calculated as 660,000 yen.

In the present embodiment, part of the total profit return amount is distributed from the manager user (management entity that invests in each of the business practice users) to each of the business practice users as a market creation contribution cost. As described above, the business practice users belonging to the collaborative organization are engaged in businesses in different fields. These businesses in different fields may organically overlap in the future to form a larger market. To sum up, since engagement of each of the business practice users in business can be regarded as leading to market creation, part of the total profit return amount is distributed from the manager user to each of the business practice users as the contribution cost for such market creation.

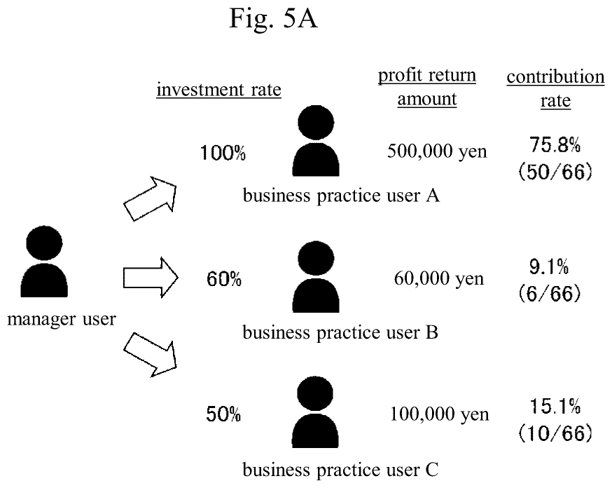

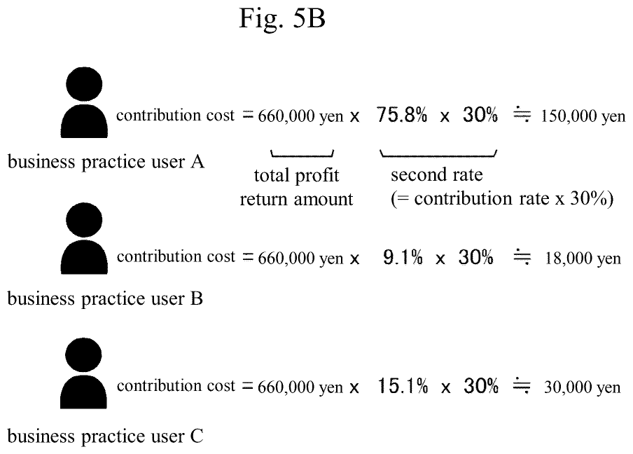

Thus, the server 300 calculates the contribution cost corresponding to the aforementioned market creation contribution cost (S109). Specifically, the server 300 calculates, for each of the business practice users belonging to the collaborative organization, the contribution cost by multiplying the summed profit return amounts (the total profit return amount) by a predetermined second rate based on a contribution rate of the user. This will be described based on FIGS. 5A and 5B.

FIGS. 5A and 5B are first diagrams for explaining the contribution costs calculated for the respective business practice users. Herein, FIG. 5A is a diagram illustrating the profit return amounts and the contribution rates for the three business practice users (business practice users A, B, and C) shown in FIGS. 4A and 4B above, and FIG. 5B is a diagram showing an example of calculating the contribution costs based on the information shown in FIG. 5A.

In the present embodiment, as shown in FIG. 5A, the contribution rate (contribution rate to a profit return) for each of the business practice users is calculated by dividing the profit return amount of each of the business practice users by the total profit return amount. In the present embodiment, as shown in FIG. 5B, the second rate is set to contribution rate ×30%. For business practice user A, the total profit return amount is 660,000 yen, and the contribution rate is 75.8%. To sum up, the second rate is 22.7%, and thereby, the contribution cost is calculated as 150,000 yen. Similarly, for business practice user B, the total profit return amount is 660,000 yen, and the contribution rate is 9.1%. To sum up, the second rate is 2.7%, and thereby, the contribution cost is calculated as 18,000 yen. For business practice user C, the total profit return amount is 660,000 yen, and the contribution rate is 15.1%. To sum up, the second rate is 4.5%, and thereby, the contribution cost is calculated as 30,000 yen.

The distribution of part of the total profit return amount as the contribution costs to the business practice users in this way means that returnable profits are shared among the business practice users belonging to the collaborative organization and return amounts based on one user's profit can be returned to other users as well. To sum up, the mutual support among the users is thereby realized. Moreover, since the returnable profits tend to increase as the colleagues who are other business practice users belonging to the collaborative organization grow, the growth of the colleagues directly leads to one's own growth, and the chain of growth is realized in the collaborative organization. The fact that each of the business practice users belonging to the collaborative organization can mutually utilize information regarding experience, personal connections, and credibility, information regarding business ideas, products, and services, and information regarding sales within the collaborative organization can also serve as a driving force to promote such the chain of growth.

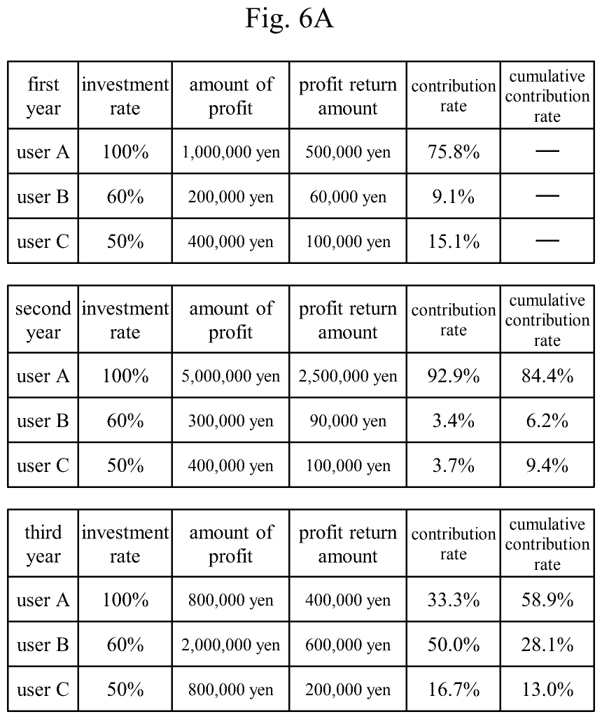

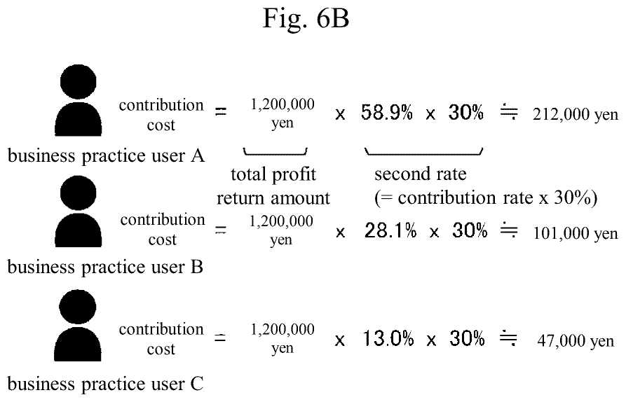

The second rate may be a rate based on the contribution rate of the business practice user in total over multiple years. This will be described based on FIGS. 6A and 6B.

FIGS. 6A and 6B are second diagrams for explaining the contribution costs calculated for the respective business practice users. Herein, FIG. 6A is a diagram illustrating the amounts of profit, the profit return amounts, the contribution rates, and cumulative contribution rates over three years for the three business practice users (business practice users A, B, and C) shown in FIGS. 4A and 4B above, and FIG. 6B is a diagram showing an example of calculating the contribution costs for the third year based on the information shown in FIG. 6A.

Each information for the first year shown in FIG. 6A is the same as that shown in FIGS. 5A and 5B above. The contribution costs for the first year are calculated as 150,000 yen for business practice user A, 18,000 yen for business practice user B, and 30,000 yen for business practice user C, which are contribution costs according to the contribution rates of the respective business practice users in that year.

In the example shown in FIG. 6A, focusing on business practice user A, the amount of profit is 5,000,000 yen in the second year and significantly increased from the first year, but the amount of profit is 800,000 yen in the third year and decreased compared to the first year. When considering only the third year, the contribution rate of business practice user A is 33.3%, which is lower than the contribution rate of business practice user B. Thus, when the contribution costs are calculated according to the contribution rates of the respective business practice users in that year, the contribution cost obtained by business practice user A becomes smaller than the contribution cost obtained by business practice user B.

On the other hand, regarding the profit returns over three years, business practice user A has contributed more than business practice user B. Specifically, for example, when the contribution rate in total over multiple years is calculated as the cumulative contribution rate for each of the business practice users by arithmetically averaging the contribution rates of the first and second years for the second year and by arithmetically averaging the contribution rates of the first, second, and third years for the third year, the cumulative contribution rate of business practice user A in the third year becomes 58.9%, and is higher than the cumulative contribution rate 28.1% of business practice user B in the third year.

By calculating the contribution costs based on such cumulative contribution rates, even if the amount of profit of each of the business practice users fluctuates annually, the fluctuation can be mitigated by the cumulative contribution rates, the contribution of each of the business practice users is continuously returned, and thereby, continuous mutual support among the users is realized.

Specifically, as shown in FIG. 6B, the second rate in this case is set to cumulative contribution rate ×30%. For business practice user A, the total profit return amount is 1,200,000 yen, and the cumulative contribution rate is 58.9%. To sum up, the second rate is 17.7%, and thereby, the contribution cost is calculated as 212,000 yen. Similarly, for business practice user B, the total profit return amount is 1,200,000 yen, and the cumulative contribution rate is 28.1%. To sum up, the second rate is 8.4%, and thereby, the contribution cost is calculated as 101,000 yen. For business practice user C, the total profit return amount is 1,200,000 yen, and the cumulative contribution rate is 13.0%. To sum up, the second rate is 3.9%, and thereby, the contribution cost is calculated as 47,000 yen. In this way, even if the contribution rate of business practice user A in the third year was relatively low, a relatively large amount of the total profit return amount for the third year is returned to business practice user A as the contribution cost according to the cumulative contribution rate that takes into account the contribution rates up to that point.

Returning to FIG. 3, the server 300 transmits the amount of the contribution costs calculated in the processing of S109 to the user terminals 400 of the manager user and the business practice users. Then, the user terminals 400 of the manager user and the business practice users acquire the information transmitted from the server 300 (S110). This enables the manager user (management entity that invests in each of the business practice users) to grasp the market creation contribution cost to be distributed to each of the business practice users and implement the distribution processing. Furthermore, each of the business practice users can also grasp the market creation contribution cost that can be distributed to themselves.

Through such processing, the business practice users belonging to the collaborative organization can mutually utilize information regarding experience, personal connections, and credibility possessed by other users, information regarding business ideas, products, and services, and information regarding sales, and the chain of growth is promoted in the collaborative organization through sharing of the returnable profits among the business practice users belonging to the collaborative organization. To sum up, the cooperation from the colleagues belonging to the same collaborative organization can be obtained for the realization of individual dreams and hopes.

According to the information processing system 100 described above, the mutual support among the users can be suitably implemented.

### Second Embodiment

The information processing system 100 according to a second embodiment will be described. In the present embodiment, the server 300 further executes providing recommendation information for organizing the collaborative organization to the manager user.

As described in the explanation of the first embodiment above, the information processing system 100 can promote the chain of growth of each of the business practice users in the collaborative organization. However, if the collaborative organization is not appropriately organized, mutual utilization of information within the collaborative organization is not effectively performed, and situations may arise where the chain of growth is hindered.

Thus, the server 300 provides information regarding experience, personal connections, and credibility possessed by each of the business practice users, information regarding business ideas, products, services, and information regarding sales to the manager user who organizes the collaborative organization in advance as the recommendation information for organizing the collaborative organization.

Then, when the manager user combines the business practice users who are engaged in businesses in different fields to organize the collaborative organization, it becomes possible to organize the collaborative organization after sufficiently considering combinations that enable effective mutual utilization of information within the collaborative organization and combinations that can maximize profits from business in different fields in the collaborative organization.

In this case, the recommendation information may include information regarding the contribution rates of the business practice users that previously belonged to the collaborative organization and regarding a predetermined growth rate of the collaborative organization that the business practice users previously belonged to. The aforementioned growth rate is, for example, a rate of increase or decrease in the total profit return amount comparing the first year and the final year when the business practice users belonged to the collaborative organization, regarding the total profit return amount over multiple years in the collaborative organization.

Information regarding the contribution rates of the business practice users in the collaborative organization that the business practice users previously belonged to represents the profit contribution of the business practice users to the collaborative organization. Thus, a business practice user whose contribution rate is high can be considered to effectively utilize information shared within the collaborative organization and achieve results in the business in which the business practice user is engaged. The growth rate of the collaborative organization that the business practice users previously belonged to represents the chain of growth of each of the business practice users in the collaborative organization. Thus, a business practice user who belonged to a collaborative organization whose growth rate is high can be considered to have contributed to the growth of the organization without sparing the cooperation with the colleagues belonging to the collaborative organization.

Then, by the server 300 providing the contribution rates and the growth rate as the recommendation information to the manager user, the manager user can organize the collaborative organization after sufficiently considering the combinations that can maximize the chain of growth of each of the business practice users in the collaborative organization.

According to the information processing system 100 described above, the mutual support among the users can also be suitably implemented.

### Other Modifications

The above embodiments are merely examples, and the present disclosure can be implemented with appropriate modifications within the scope that does not depart from the gist thereof. For example, the processing and the means described in the present disclosure can be freely combined and implemented as long as no technical contradiction arises.

Furthermore, the processing described as being performed by one apparatus may be shared and executed by multiple apparatuses. For example, the first acquisition unit 3031 and the provision unit 3032 may be formed in an arithmetic processing apparatus separate from the server 300. In this case, the separate arithmetic processing apparatus is configured to be able to cooperate suitably with the server 300. In contrast, the processing described as being performed by different apparatuses may also be executed by one apparatus. In a computer system, how hardware configuration (server configuration) for each function is realized can be flexibly changed.

The present disclosure can also be realized by supplying the computer program implementing the functions described in the above embodiments to the computer, and by having one or more processors of the computer read and execute the program. Such a computer program may be provided to the computer by a non-transitory computer readable storage medium connectable to the computer's system bus, or may be provided to the computer via the network. Examples of the non-transitory computer readable storage medium include any type of medium such as a magnetic disk (floppy (registered trademark) disk, hard disk drive (HDD), etc.), and optical disk (CD-ROM, DVD disk, Blu-ray disk, etc.); a read-only memory (ROM), a random access memory (RAM), an EPROM, an EEPROM, a magnetic card, a flash memory, an optical card, and any type of medium suitable for storing electronic instructions.

### REFERENCE SIGNS LIST

100 . . . information processing system
200 . . . network
300 . . . server
301 . . . communication unit
302 . . . storage unit
303 . . . control unit
400 . . . user terminal

What is claimed is:

1. An information processing apparatus for managing mutual support among business practice users, the information processing apparatus comprising a control unit configured to execute:
acquiring predetermined first information from each of the business practice users belonging to a collaborative organization in which the business practice users are organized, the business practice users being engaged in businesses in different fields;
providing the first information to a predetermined network in a browsable manner so that each of the business practice users belonging to the collaborative organization can mutually share information;
acquiring, for each of the business practice users belonging to the collaborative organization, an amount of profit obtained from the business by the business practice user;
acquiring, from a manager user who invests in each of the business practice users, an investment rate for each of the business practice users;
summing up profit return amounts for respective business practice users, each of the profit return amounts being obtained by multiplying the amount of profit by a predetermined first rate based on the investment rate from the manager user;
calculating, for each of the business practice users belonging to the collaborative organization, a contribution rate of the business practice user by dividing the profit return amount of the business practice user by a total profit return amount that is the summed profit return amounts; and
calculating, for each of the business practice users belonging to the collaborative organization, a contribution cost to be obtained by multiplying the total profit return amount by a predetermined second rate based on the contribution rate of the business practice user, the contribution cost being a cost to be distributed to the business practice user.

2. The information processing apparatus according to claim 1, wherein
the second rate is a rate based on the contribution rate of the business practice user in total over multiple years.

3. The information processing apparatus according to claim 1, wherein
the control unit is configured to further execute:
providing recommendation information for organizing the collaborative organization to the manager user.

4. The information processing apparatus according to claim 3, wherein
the recommendation information includes information regarding the contribution rate of the business practice user that previously belonged to the collaborative organization and regarding a predetermined growth rate of the collaborative organization that the business practice user previously belonged to.

5. An information processing method for managing mutual support among business practice users, wherein
a computer is configured to execute:
acquiring predetermined first information from each of the business practice users belonging to a collaborative organization in which the business practice users are organized, the business practice users being engaged in businesses in different fields;
providing the first information to a predetermined network in a browsable manner so that each of the business practice users belonging to the collaborative organization can mutually share information;
acquiring, for each of the business practice users belonging to the collaborative organization, an amount of profit obtained from the business by the business practice user;
acquiring, from a manager user who invests in each of the business practice users, an investment rate for each of the business practice users;
summing up profit return amounts for respective business practice users, each of the profit return amounts being obtained by multiplying the amount of profit by a predetermined first rate based on the investment rate from the manager user;
calculating, for each of the business practice users belonging to the collaborative organization, a contribution rate of the business practice user by dividing the profit return amount of the business practice user by a total profit return amount that is the summed profit return amounts; and
calculating, for each of the business practice users belonging to the collaborative organization, a contribution cost to be obtained by multiplying the total profit return amount by a predetermined second rate based on the contribution rate of the business practice user, the contribution cost being a cost to be distributed to the business practice user.

6. A non-transitory computer readable medium having stored thereon an information processing program for managing mutual support among business practice users, wherein
the information processing program causes a computer to execute:
acquiring predetermined first information from each of the business practice users belonging to a collaborative organization in which the business practice users are organized, the business practice users being engaged in businesses in different fields;
providing the first information to a predetermined network in a browsable manner so that each of the business practice users belonging to the collaborative organization can mutually share information;
acquiring, for each of the business practice users belonging to the collaborative organization, an amount of profit obtained from the business by the business practice user;
acquiring, from a manager user who invests in each of the business practice users, an investment rate for each of the business practice users;
summing up profit return amounts for respective business practice users, each of the profit return amounts being obtained by multiplying the amount of profit by a predetermined first rate based on the investment rate from the manager user;
calculating, for each of the business practice users belonging to the collaborative organization, a contribution rate of the business practice user by dividing the profit return amount of the business practice user by a total profit return amount that is the summed profit return amounts; and
calculating, for each of the business practice users belonging to the collaborative organization, a contribution cost to be obtained by multiplying the total profit return amount by a predetermined second rate based on the contribution rate of the business practice user, the contribution cost being a cost to be distributed to the business practice user.
